(19) United States
(12) Patent Application Publication
(10) Pub. No.: US 2019/0013154 A1
(43) Pub. Date: Jan. 10, 2019

(54) ELECTROLYTIC CAPACITOR

(71) Applicant: Panasonic Intellectual Property Management Co., Ltd., Osaka (JP)

(72) Inventors: YUKARI SHIMAMOTO, Kyoto (JP); HIROSHI YOSHIDA, Kyoto (JP); KYOHEI KOBAYASHI, Hyogo (JP)

(21) Appl. No.: 16/128,684

(22) Filed: Sep. 12, 2018

Related U.S. Application Data
(63) Continuation of application No. PCT/JP2017/001891, filed on Jan. 20, 2017.

(30) Foreign Application Priority Data
Mar. 25, 2016 (JP) 2016-062582

(51) Int. Cl. H01G 9/055; H01G 9/15; H01G 9/012

(52) U.S. Cl. CPC H01G 9/055; H01G 9/07; H01G 9/012; H01G 9/15

(57) ABSTRACT

An electrolytic capacitor includes a capacitor element and an anode terminal. The capacitor element includes an anode body, a dielectric layer on the anode body, a solid electrolyte layer on the dielectric layer, and a cathode lead-out layer on the solid electrolyte layer, the anode body having a sheet shape and including a first side edge and a second side edge opposite to the first side edge. The anode body includes a first region close to the first side edge, a second region close to the second side edge, and a boundary between the first region and the second region. The first region includes an etched surface, and the second region includes a non-etched surface. The anode body further includes a narrowed part having a length shortened in a direction along the second side edge. The dielectric layer is disposed on a surface of the first region. A side edge of a cutout is disposed in the second region. The cutout forms the narrowed part. The anode terminal is connected with the second region.

### RELATED APPLICATIONS

This application is a continuation of the PCT International Application No. PCT/JP2017/001891 filed on Jan. 20, 2017, which claims the benefit of foreign priority of Japanese patent application No. 2016-062582 filed on Mar. 25, 2016, the contents all of which are incorporated herein by reference.

### BACKGROUND

### 1. Technical Field

The present disclosure relates to an electrolytic capacitor, and particularly to internal short-circuit prevention.

### 2. Description of the Related Art

A metal sheet containing valve metal is used as an anode body of a capacitor element. All or part of a principal surface of the metal sheet is etched to increase capacitance of the capacitor element. For example, Unexamined Japanese Patent Publication No. 2005-340794 discloses that a principal surface of metal foil is partially masked and etched, and then subjected to anodization processing.

When a cathode part is provided by forming a solid electrolyte layer and a cathode lead-out layer on a part etched and subjected to anodization processing, an insulating member is disposed between the etched region and a non-etched region in some cases. Thus, the insulating member reduces creeping of solid electrolyte to the non-etched region when the solid electrolyte layer is formed. Accordingly, the cathode part is separated from an anode part as a region of the anode body other than the cathode part. The anode part is joined with an anode terminal, and thus the separation of the cathode part and the anode part leads to reduction of internal short-circuit.

### SUMMARY

An electrolytic capacitor according to the present disclosure includes a capacitor element and an anode terminal. The capacitor element includes an anode body, a dielectric layer on the anode body, a solid electrolyte layer on the dielectric layer, and a cathode lead-out layer on the solid electrolyte layer, the anode body having a sheet shape and including a first side edge and a second side edge opposite to the first side edge. The anode body includes a first region close to the first side edge, a second region close to the second side edge, and a boundary between the first region and the second region. The first region includes an etched surface, and the second region includes a non-etched surface. The anode body further includes a narrowed part having a length shortened in a direction along the second side edge. The dielectric layer is disposed on a surface of the first region. A side edge of a cutout is disposed in the second region. The cutout forms the narrowed part. The anode terminal is connected with the second region.

According to the present disclosure, a degree of creeping of solid electrolyte at an anode part can be reduced. As a result, internal short-circuit between the anode part and a cathode part can be prevented.

### BRIEF DESCRIPTION OF THE DRAWINGS

FIG. 1 is a cross-sectional view schematically illustrating a capacitor element according to an exemplary embodiment of the present disclosure;

FIG. 2 is a top view schematically illustrating an anode body according to the exemplary embodiment of the present disclosure; and

FIG. 3 is an enlarged top view illustrating a main part of the anode body illustrated in FIG. 2; and

FIG. 4 is a cross-sectional view schematically illustrating an electrolytic capacitor according to the exemplary embodiment of the present disclosure.

### DETAILED DESCRIPTION OF EMBODIMENT

In a conventional electrolytic capacitor, creeping of solid electrolyte from a principal surface of a cathode part is reduced by disposing an insulating member. However, at an edge (end face) of an anode part including a non-etched part, solid electrolyte creeps from an end face of a cathode part to the end face of the anode part in some cases. When the solid electrolyte has crept to the end face of the anode part, the solid electrolyte eventually spreads to a principal surface of the anode part, and potentially contacts with an anode terminal, causing internal short-circuit.

An electrolytic capacitor includes a capacitor element that includes an anode body, a dielectric layer on the anode body, a solid electrolyte layer on the dielectric layer, and a cathode lead-out layer on the solid electrolyte layer. The anode body has a sheet shape and includes a first side edge and a second side edge opposite to the first side edge. The anode body includes a first region close to the first side edge, a second region close to the second side edge, and a boundary between the first region and the second region. The first region includes an etched surface, and the second region includes a non-etched surface. The anode body further includes a narrowed part having a length shortened in a direction along the second side edge. A side edge of a cutout forming the narrowed part is entirely disposed in the second region. The dielectric layer is disposed on a surface of the first region. The second region is connected with an anode terminal.

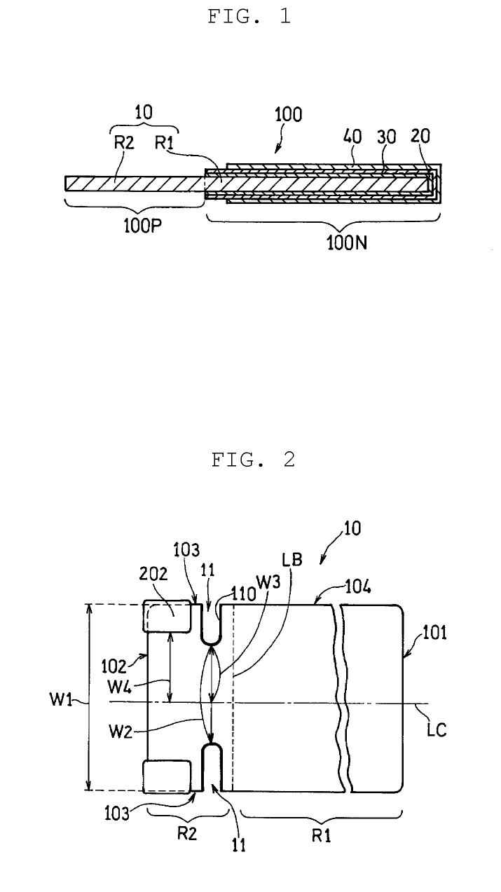

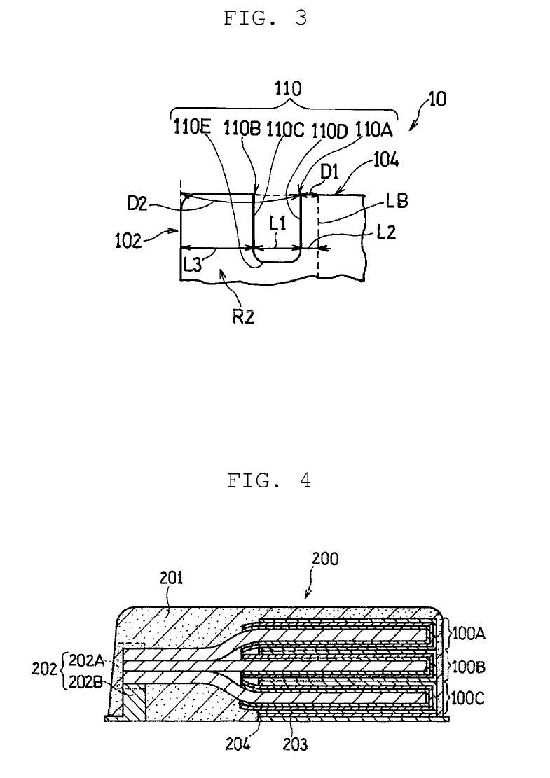

A configuration of an anode body according to the present exemplary embodiment will be described below in detail with reference to the accompanying drawings. FIG. 1 is a cross-sectional view schematically illustrating capacitor element 100 according to the present exemplary embodiment. FIG. 2 is a top view schematically illustrating anode body 10 according to the present exemplary embodiment. FIG. 3 is an enlarged top view illustrating a main part of anode body 10 (near narrowed part 11) illustrated in FIG. 2.

### (Capacitor Element)

Capacitor element 100 includes sheet anode body 10, dielectric layer 20 formed on at least part of a surface of anode body 10, solid electrolyte layer 30 formed on at least part of a surface of dielectric layer 20, and cathode lead-out layer 40 formed on at least part of a surface of solid electrolyte layer 30. Capacitor element 100 has a sheet shape.

Anode body 10 includes first region R1 having an etched surface and second region R2 having a non-etched surface. Dielectric layer 20 is formed at least on the surface of first region R1. First region R1, dielectric layer 20, solid electrolyte layer 30, and cathode lead-out layer 40 serve as cathode part 100N of capacitor element 100. Second region R2 serves as anode part 100P of capacitor element 100. Anode part 100P (in other words, second region R2) is joined and electrically connected with anode terminal 202 (refer to FIG. 2).

### (Anode Body)

Anode body 10 is a sheet containing valve metal as conductive material. Examples of the valve metal include titanium, tantalum, aluminum, and niobium. Anode body 10 may contain one, or two or more of the above-described valve metals. Anode body 10 may contain valve metals as alloy or intermetallic compound. Anode body 10 is not limited to a particular thickness, but may have a thickness ranging from 15 μm to 300 μm, inclusive, for example.

First region R1 is disposed at a side closer to first side edge 101 of anode body 10. And at least the surface of first region R1 is etched. First region R1 may or may not include first side edge 101. Second region R2 is disposed at a side closer to second side edge 102 opposite to first side edge 101. And second region R2 is not etched. Second region R2 may or may not include second side edge 102. FIGS. 2 and 3 each illustrate a boundary between first region R1 and second region R2 with a dashed line (boundary LB). Boundary LB is a boundary between a region having an uneven surface and a region having a smooth surface. When there are a plurality of such boundaries, boundary LB is a boundary closest to second side edge 102.

Anode body 10 includes narrowed part 11 having a length shortened in a direction along second side edge 102 (direction parallel to second side edge 102). Narrowed part 11 is formed by cutting out part of second region R2 along the direction parallel to second side edge 102. Side edge 110 of a cutout forming narrowed part 11 is entirely disposed in second region R2. Mechanical strength of a non-etched part is higher than mechanical strength of an etched part. Thus, by disposing side edge 110 of the cutout entirely in non-etched second region R2, decrease in mechanical strength of anode body 10 due to formation of narrowed part 11 can be reduced. In addition, defect of anode body 10 due to the formation of narrowed part 11 by punching out anode body 10 is reduced.

By providing narrowed part 11 in second region R2, creeping of the solid electrolyte from the surface of first region R1 is suppressed. In addition, a creeping path of the solid electrolyte at an end face of anode body 10 is diverted to side edge 110 of the cutout of narrowed part 11. In other words, narrowed part 11 reduces a degree of creeping of the solid electrolyte from the surface and end face of first region R1 to second region R2. A thin dielectric layer is formed on a surface of anode part 100P in some cases. Thus, in order to prevent internal short-circuit, it is important that the solid electrolyte does not reach anode terminal 202.

To facilitate such effects of narrowed part 11, anode terminal 202 is preferably connected with second region R2 between narrowed part 11 and second side edge 102. In particular, anode terminal 202 is preferably disposed near third side edge 103 intersecting second side edge 102. Since creeping of solid electrolyte layer 30, which is interfered by narrowed part 11, does not reach anode terminal 202, short-circuit between anode part 100P and cathode part 100N is suppressed. Anode terminal 202 is at least one of anode lead 202B connecting capacitor element 100 with outside and swaging member 202A electrically connected with anode lead 202B (refer to FIG. 4). Swaging member 202A is used to swage the plurality of capacitor elements 100, for example.

In addition, shortest distance W3 between side edge 110 of the cutout and central line LC is preferably shorter than shortest distance W4 between anode terminal 202 and central line LC. In other words, a depth (length in a direction orthogonal to central line LC) of the cutout at narrowed part 11 is greater than a length of anode terminal 202 in the direction orthogonal to central line LC. Accordingly, the solid electrolyte is more unlikely to reach anode terminal 202. Central line LC is a straight line extending in a direction orthogonal to both of the direction along second side edge 102 and a thickness direction of anode body 10 and equally dividing anode body 10.

An insulating member may be disposed between first region R1 and second region R2. No insulating member may be used when first region R1 is etched to form an abrupt slope or a step near boundary LB. This is because creeping of the solid electrolyte from the surface of first region R1 is more likely to be reduced due to such a height difference near boundary LB.

In FIG. 2, two narrowed parts 11 are provided at positions opposite to each other with respect to central line LC, but the present disclosure is not limited to this configuration. For example, one narrowed part 11 may be provided, or narrows parts 11 may be provided asymmetrically with respect to central line LC. Narrowed parts 11 are preferably provided at two positions opposite to each other with respect to central line LC because the degree of creeping of the solid electrolyte is likely to be reduced.

Each narrowed part 11 is disposed near boundary LB, for example. In this case, the solid electrolyte having crept to the end face of anode body 10 is diverted near boundary LB. Accordingly, creeping of the solid electrolyte from the end face of anode body 10 is reduced near boundary LB. In other words, the degree of creeping of the solid electrolyte in second region R2 is further reduced. For example, as illustrated in FIG. 3, when one end part (first end part 110A) of side edge 110 of the cutout is connected with fourth side edge 104 intersecting first side edge 101, and another end part (second end part 110B) of side edge 110 of the cutout is connected with third side edge 103 intersecting second side edge 102, a ratio D1/D2 of distance D1 between first end part 110A and boundary LB with respect to distance D2 between first end part 110A and second side edge 102 preferably ranges from 0.01 to 1.25, inclusive. In particular, distance D1 is more preferably shorter than distance D2. Specifically, the ratio D1/D2 is preferably equal to or larger than 0.01 and smaller than 1.0.

Distance D1 is a shortest distance between first end part 110A and boundary LB. Similarly, distance D2 is a shortest distance between first end part 110A and second side edge 102. When anode body 10 includes a round corner and a boundary between second side edge 102 and third side edge 103 is unclear, distance D2 is set to be a shortest distance between an extended line from second side edge 102 and first end part 110A as illustrated in FIG. 3.

The length of narrowed part 11 in the direction along second side edge 102 is preferably as small as possible as compared to width W1 of second side edge 102 for reducing the degree of creeping of the solid electrolyte from the surface and side edge of first region R1. On the other hand, in order to maintain strength of anode body 10, the length of narrowed part 11 is preferably not excessively smaller than width W1 of second side edge 102. With these requirements taken into consideration, a ratio W2/W1 of shortest length W2 in the direction along second side edge 102 at narrowed part 11 with respect to width W1 of second side edge 102 preferably ranges from 0.25 to 0.5, inclusive. When anode body 10 includes a round corner, width W1 is set to be a shortest distance between two extended lines of third side edges 103 as illustrated in FIG. 2.

Narrowed part 11 is not limited to a particular shape. In particular, side edge 110 of the cutout forming narrowed part 11 preferably includes, at a side closer to second side edge 102, first straight part 110C extending in the direction along second side edge 102 as illustrated in FIG. 3. Accordingly, when second region R2 does not have a sufficient area, side edge 110 of the cutout can have a long length as possible while maintaining a sufficient area between narrowed part 11 and second side edge 102. Thus, second region R2 can be easily joined with anode terminal 202. For example, because side edge 110 of the cutout has a simple shape, when narrowed part 11 is formed by punching out anode body 10, a blade used in the punching has a simple shape, thereby accurately forming narrowed part 11.

Side edge 110 of the cutout preferably includes, at a side closer to boundary LB, second straight part 110D extending in the direction along second side edge 102. Since side edge 110 of the cutout at the side closer to boundary LB, which functions as a first barrier against creeping of the solid electrolyte on the surface of second region R2, is disposed orthogonally to a direction of creeping of the solid electrolyte, the degree of creeping of the solid electrolyte in second region R2 is further reduced.

For these reasons, a preferable shape of side edge 110 of the cutout is, for example, a U shape including first straight part 110C and second straight part 110D in parallel to second side edge 102. Connection part 110E connecting first straight part 110C and second straight part 110D is not limited to a particular shape, but may be a straight shape or a curved shape.

A ratio L2/L1 of distance L2 between boundary LB and second straight part 110D with respect to distance L1 between first straight part 110C and second straight part 110D preferably ranges from 0.1 to 4.0, inclusive, more preferably ranges from 0.1 to 0.5, inclusive. When narrowed part 11 is disposed close to boundary LB, creeping of the solid electrolyte across narrowed part 11 is more likely to be reduced because side edge 110 of the cutout includes second straight part 110D in the direction parallel to second side edge 102 and distance L1 is sufficiently long.

When side edge 110 of the cutout has the U shape including first straight part 110C and second straight part 110D, a ratio L2/L3 of distance L2 between boundary LB and second straight part 110D with respect to distance L3 between first straight part 110C and second side edge 102 preferably ranges from 0.1 to 1.7, inclusive, more preferably ranges from 0.1 to 0.3, inclusive. Accordingly, an area sufficient for connection of anode terminal 202 is obtained in a region between first straight part 110C and second side edge 102. When anode terminal 202 is disposed near first straight part 110C, creeping of the solid electrolyte is interfered by narrowed part 11, and as a result, internal short-circuit is reduced.

Distance L1 is an average value of lengths of lines extending from optional three points at first straight part 110C to second straight part 110D in a direction orthogonal to first straight part 110C. Distances L2 and L3 are average values, too, and can be calculated similarly.

### (Dielectric Layer)

Dielectric layer 20 is formed through oxidation of the surface of first region R1 by performing, for example, anodization processing. The anodization may be achieved by a well-known method. Dielectric layer 20 is not particularly limited, but may be any insulating layer functioning as dielectric. Dielectric layer 20 is formed at least on the surface of first region R1.

### (Solid Electrolyte Layer)

Solid electrolyte layer 30 is formed on at least part of the surface of dielectric layer 20. Solid electrolyte layer 30 contains, for example, manganese compound and conductive polymer. Examples of the conductive polymer include polypyrrole, polythiophene, polyaniline, and derivatives of polypyrrole, polythiophene, and polyaniline.

Solid electrolyte layer 30 containing a conductive polymer can be formed through, for example, chemical polymerization or electrolytic polymerization of raw material monomer on dielectric layer 20. Alternatively, solid electrolyte layer 30 may be formed by applying, to dielectric layer 20, liquid containing conductive polymer polymerized in advance.

### (Cathode Lead-Out Layer)

Cathode lead-out layer 40 is formed on at least part of the surface of solid electrolyte layer 30. The cathode lead-out layer 40 includes, for example, a carbon layer and a metal (e.g., silver) paste layer formed on a surface of the carbon layer. Cathode lead-out layer 40 is formed by sequentially applying carbon paste and silver paste.

### (Electrolytic Capacitor)

For example, as illustrated in FIG. 4, electrolytic capacitor 200 includes a plurality of stacked capacitor elements 100 (100A to 100C), outer package body 201 sealing each capacitor element 100, anode terminal 202 electrically connected with second region R2, and cathode terminal 203 electrically connected with cathode lead-out layer 40. For example, capacitor elements 100 are joined with each other by laser welding, resistance welding, needle swaging, brazing and soldering, or the like at a predetermined position in each anode part 100P, and are electrically connected with each other. Adjacent capacitor elements 100 may be joined with each other through another conductive member (for example, a metal plate or a metal piece). Although electrolytic capacitor 200 according to the present embodiment includes three capacitor elements 100, a number of included capacitor elements 100 is not limited. Electrolytic capacitor 200 includes, for example, 1 to 15 capacitor elements 100.

### (Anode Terminal)

Capacitor elements 100 are joined with each other in second region R2 as illustrated in FIG. 4 and also may be swaged by swaging member 202A. This improves reliability of connection between stacked capacitor elements 100. Swaging member 202A is electrically connected with anode lead 202B. In this case, anode terminal 202 includes swaging member 202A, and anode lead 202B electrically connected with swaging member 202A. Part of anode lead 202B is exposed out of outer package body 201.

Swaging member 202A is joined with each of second regions R2 of two outermost capacitor elements (in FIG. 4, capacitor elements 100A and 100C). For example, a plurality of capacitor elements are joined with each other by laser welding, and then swaging member 202A is disposed to sandwich capacitor element group at a position corresponding to this welded part. Then, laser welding is further performed in this state to join swaging member 202A and capacitor element group with each other. Swaging member 202A may be fabricated, for example, by bending a flat plate member.

Anode lead 202B is electrically connected with second region R2 of each capacitor element 100 through swaging member 202A. Anode lead 202B and swaging member 202A may be integrated with each other. Materials of swaging member 202A and anode lead 202B are not particularly limited but may be any conductive materials.

### (Outer Package Body)

Outer package body 201 is formed of, for example, insulating resin. Examples of the insulating resin include epoxy resin, phenol resin, silicone resin, melamine resin, urea resin, alkyd resin, polyurethane, polyimide, polyamide-imide, and unsaturated polyester.

### (Cathode Terminal)

Cathode terminal 203 is electrically connected with cathode lead-out layer 40. A material of cathode terminal 203 is not particularly limited but may be any conductive material. Cathode terminal 203 is joined with cathode lead-out layer 40 through, for example, conductive adhesive agent 204 as described above.

The electrolytic capacitor according to the present disclosure has excellent reliability and thus is applicable to various usages.

What is claimed is:

1. An electrolytic capacitor comprising:
a capacitor element including an anode body, a dielectric layer on the anode body, a solid electrolyte layer on the dielectric layer, and a cathode lead-out layer on the solid electrolyte layer, the anode body having a sheet shape and including a first side edge and a second side edge opposite to the first side edge; and
an anode terminal, wherein:
the anode body includes a first region close to the first side edge, a second region close to the second side edge, and a boundary between the first region and the second region, the first region including an etched surface, the second region including a non-etched surface,
the anode body further includes a narrowed part having a length shortened in a direction along the second side edge,
the dielectric layer is disposed on the etched surface of the first region,
a side edge of a cutout is disposed in the second region, the cutout forming the narrowed part, and
the anode terminal is connected with the second region.

2. The electrolytic capacitor according to claim 1, wherein:
the anode body includes a third side edge intersecting the second side edge, and a fourth side edge intersecting the first side edge,
the side edge of the cutout includes a first end part connected with the fourth side edge, and a second end part connected with the third side edge, and
a distance D1 between the first end part and the boundary is shorter than a distance D2 between the first end part and the second side edge.

3. The electrolytic capacitor according to claim 1, wherein a ratio W2/W1 of a length W2 of the narrowed part in the direction along the second side edge with respect to a length W1 of the second side edge ranges from 0.25 to 0.5, inclusive.

4. The electrolytic capacitor according to claim 1, wherein the side edge of the cutout includes a first straight part extending in the direction along the second side edge, the first straight part being closer to the second side edge.

5. The electrolytic capacitor according to claim 1, wherein the side edge of the cutout includes a second straight part extending in the direction along the second side edge, the second straight part being closer to the boundary.

6. The electrolytic capacitor according to claim 1, wherein:
the side edge of the cutout includes a first straight part extending in the direction along the second side edge at a side closer to the second side edge, and a second straight part extending in the direction along the second side edge at a side closer to the boundary, and
a ratio L2/L1 of a distance L2 between the boundary and the second straight part with respect to a distance L1 between the first straight part and the second straight part ranges from 0.1 to 4.0, inclusive.

7. The electrolytic capacitor according to claim 1, wherein:
the anode terminal is disposed between the narrowed part and the second side edge, and
a shortest distance W3 between a central line and the side edge of the cutout is shorter than a shortest distance W4 between the anode terminal and the central line, the central line extending in a direction orthogonal to both of the direction along the second side edge and a thickness direction of the anode body and equally dividing the anode body.
